(19) United States
(12) Patent Application Publication
(10) Pub. No.: US 2014/0002598 A1
(43) Pub. Date: Jan. 2, 2014

(54) TRANSPORT SYSTEM AND CLIENT SYSTEM FOR HYBRID 3D CONTENT SERVICE

(71) Applicant: Electronics and Telecommunications Research Institute, Daejeon (KR)

(72) Inventors: Tae-Jung KIM, Cheongju (KR); Jae-Ho KIM, Gyeryong (KR); Chang-Ki KIM, Daejeon (KR); Jeong-Ju YOO, Daejeon (KR); Jin-Woo HONG, Daejeon (KR)

(21) Appl. No.: 13/922,538

(22) Filed: Jun. 20, 2013

(30) Foreign Application Priority Data
Jun. 29, 2012 (KR) 10-2012-0070948
Feb. 27, 2013 (KR) 10-2013-0021539

(51) Int. Cl. H04N 13/00

(52) U.S. Cl. CPC H04N 13/0048
USPC 348/43

(57) ABSTRACT

A transport system for a hybrid 3D content service is provided. This system includes: an SVC encoder configured to encode 3D content of a left image and a right image, and a hybrid network transmission streaming module configured to transmit a base layer (BL) stream from among scalable bitstreams encoded by the SVC encoder to a client system through a broadcasting network, and to transmit an enhancement layer (EL) stream to the client system through an Internet network.

### CROSS-REFERENCE TO RELATED APPLICATION

This application claims the benefit under 35 U.S.C. §119(a) of Korean Patent Application Nos. 10-2012-0070948, filed on Jun. 29, 2012, and 10-2013-0021539, filed on Feb. 27, 2013, the entire disclosures of which are incorporated herein by references for all purposes.

### BACKGROUND

1. Field

The following description relates to technology for providing a 3D content service, and more particularly, to technology for providing hybrid 3D content using a broadcasting network and an Internet network.

2. Description of the Related Art

As major TV manufacturers such as Samsung Electronics and LG Electronics supply more and more 3D TVs, domestic and foreign broadcasting companies are now providing or preparing 3D TV services. The British company BSkyB started an experimental 3D TV broadcast in 2008 and is actively investing in 3D service. In France, TF-1 broadcast the 2010 FIFA World Cup South Africa in 3D through IPTVs and satellites. In Germany, 3D broadcasts have been provided mainly for sporting events such as football and ice hockey. In the US, 3D TV trial services were provided mainly by cable TV companies, and the satellite channel DIREC TV has provided a 3D VOD service since June 2010. In Japan, BS11 is broadcasting documentaries, sports, soap operas, and animations for one hour a day. In Korea, the terrestrial channel KBS, the cable channels CJ Hellovision, HCN, Gangnam, C&M, Tbroad, and the IPTV channels Btv and QOOK TV are providing 3D VOD services.

In order to provide such 3D services, a service-compatible 3D service method that guarantees backward compatibility with a conventional digital TV (DTV) broadcast system has been adopted for a current broadcasting network. FIG. 1 illustrates a system configuration for this method. As illustrated, a transport system 10 encodes an image by using two codecs. Here, a left image is encoded with MPEG-2 and a right image is encoded with H.264/AVC so as to be transmitted to a client system 20 through the Internet and broadcasting network. Accordingly, a viewer of conventional DTV watches the DTV only with the left image encoded with MPEG-2, and a viewer having a 3D TV receiver watches a 3D stereoscopic image by decoding two streams.

However, according to the system structure illustrated in FIG. 1, there is a difference in quality between the left-view and right images, due to encoding loss. A 3D TV viewer may is feel discomfort due to the image quality difference. Further, a combination of MPEG-2 and H.264 requires broadband, since a full HD image is encoded and transmitted. Moreover, since the independently encoded images are transmitted through the Internet when a 3D service is provided through the broadcasting network and the Internet, the images may be leaked and reproduced freely. Therefore, an additional content protection method is required.

### SUMMARY

The following description relates to a transport system and client system for a hybrid 3D content service for reducing a quality difference between two images.

Further, the following description relates to a transport system and client system for a hybrid 3D content service for protecting the content without an additional content protection algorithm.

In one general aspect, a transport system for a hybrid 3D content service includes an SVC encoder configured to encode 3D content of a left image and a right image, and a hybrid network transport streaming module configured to transmit a base layer (BL) stream from among scalable bitstreams encoded by the SVC encoder to a client system through a broadcasting network, and to transmit an enhancement layer (EL) stream to the client system through an Internet network.

The hybrid network transport streaming module may transmit the enhancement layer stream when the enhancement layer stream is requested by the client system.

The SVC encoder may include, into supplemental enhancement information (SEI), information on the number of video images to be output by a decoder of the client system according to a type of the 3D content.

The hybrid network transport streaming module may include a layer separation unit is configured to separate the scalable bitstream encoded by the SVC encoder into a base layer and an enhancement layer, a base layer TS multiplexer configured to convert the separated base layer stream into a transport stream (TS), an enhancement layer TS multiplexer configured to convert the separated enhancement layer stream into a transport stream, and an enhancement layer providing unit configured to segment and store the enhancement layer transport stream, and stream-transmit a segment file of a corresponding point of time when the client system requests.

The enhancement layer providing unit may generate a media presentation description (MPD) file including information of the segmented enhancement layer transport stream, and may provide the file when the file is requested by the client system.

The enhancement layer providing unit may perform streaming-transmission based on a hyper text transfer protocol (HTTP).

In one general aspect, a client system for a hybrid 3D content service includes a hybrid network reception module configured to receive a transport stream (TS) including a base layer stream through a broadcasting network, and receive an enhancement layer stream through an Internet network, from a transport system, wherein the hybrid network reception module requests the enhancement layer stream from the transport system to receive the enhancement layer stream, and an adaptive SVC decoder configured to decode the streams received by the hybrid network reception module and output a 2D or 3D image.

The hybrid network reception module may include a TS demultiplexer for a base layer, configured to separate a transport stream received through the broadcasting network into a base layer stream and an audio stream, a streaming control engine configured to request a media presentation description (MPD) file to the transport system and receive the media presentation description (MPD) file from the transport system, analyze a time stamp of a 2D image provided is from the TS demultiplexer for the base layer and segment information of the received MPD file, and determine an enhancement layer segment TS file of a download start time, an access client configured to download, from the transport system, the segment TS file of a time determined by the streaming control engine, a TS demultiplexer for an enhancement layer configured to convert the downloaded enhancement layer TS file into an enhancement layer stream, and a synchronization module configured to synchronize the base layer stream with the enhancement layer stream to generate SVC NAL data that is a single scalable bitstream.

The streaming control engine may send a request to the transport system for the MPD file when a user requests a 3D view.

The adaptive SVC decoder may identify supplemental enhancement information (SEI) included in a header of an SVC network adaptation layer (NAL) that is a single scalable bitstream generated by the synchronization module, detect the number of output images, and output a 2D or 3D image according to the detected number.

Other features and aspects will be apparent from the following detailed description, the drawings, and the claims.

### BRIEF DESCRIPTION OF THE DRAWINGS

FIG. 1 is a block diagram illustrating a conventional hybrid 3D content service system using Internet and broadcasting networks;

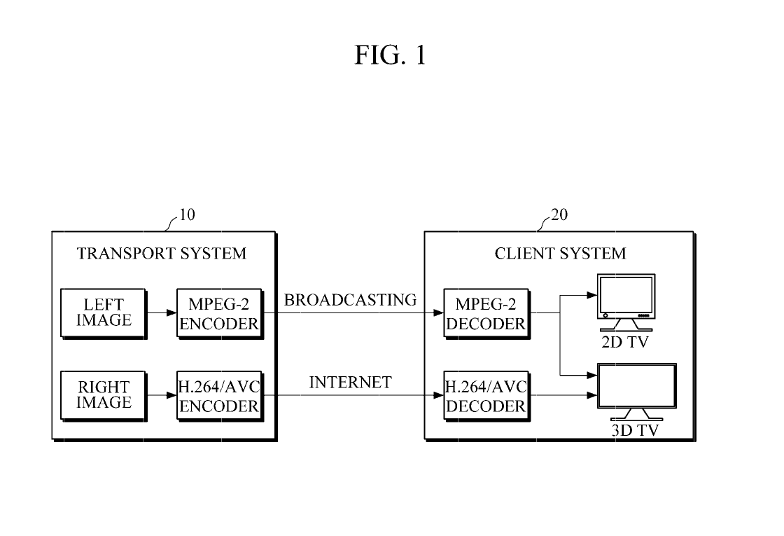

FIG. 2 is a block diagram illustrating a hybrid 3D content service system based on a multi-layer video encoding codec according to an embodiment of the present invention;

FIG. 3 is a block diagram illustrating the hybrid network transport streaming module of FIG. 2;

FIG. 4 is a block diagram illustrating the hybrid network reception module of FIG. 2;

FIG. 5 is a diagram illustrating a standard SVC decoding operation; and

FIG. 6 is a diagram illustrating an SVC decoding method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Various changes, modifications, and equivalents of the methods, apparatuses, and/or systems described herein will suggest themselves to those of ordinary skill in the art. Also, descriptions of well-known functions and constructions may be omitted for increased clarity and conciseness.

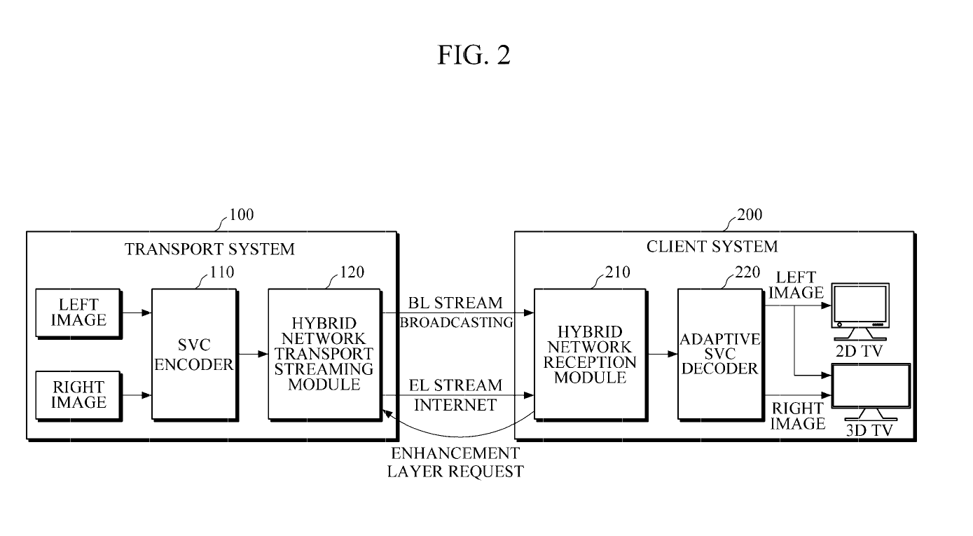

FIG. 2 is a block diagram illustrating a hybrid 3D content service system based on a multi-layer video encoding codec according to an embodiment of the present invention.

The multi-layer video encoding codec-based hybrid 3D content service system includes a transport system 100 and a client system 200. The transport system 100 has a function of generating a layer structure for compressing content based on scalable video coding (SVC) and transmitting the content to a broadcasting network and an Internet network. The transport system 100 includes an SVC encoder 110 and a hybrid network transport streaming module 120. The SVC encoder 110 receives and encodes 3D content including a left image and a right image. The SVC encoder 110 provides information indicating an output number in a supplemental is enhancement information (SEI) header according to a format of the content. A message provided in the SEI header represents the number of video images to be output by a decoder. Examples of an identify value for specifying the output number are shown in Table 1.

TABLE 1

| Output Identify Value (OID) | Description |
|---|---|
| 00 | A Single Output |
| 01 | Two outputs (BL out, EL out) |
| 10 | Two outputs (BL + EL0 out, EL1 out) |
| 11 | Reserved |

As shown in Table 1, an output identify value (OID) may be a 2-bit binary value. When the OID is ‘00’, the output number is one, indicating provision of a 2D image. A value of ‘01’ or ‘10’ indicates that the number of outputs of the decoder is two, indicating provision of a 3D image. The number of bits allocated to the OID may be increased as necessary. This bit number may be set by a provider that stores and transmits the content.

The hybrid network transport streaming module 120 transmits, through the broadcasting network, a stream of a base layer (BL) from among scalable bitstreams encoded by the SVC encoder 110. A stream of an enhancement layer (EL) is transmitted through the Internet network in response to a request from a client.

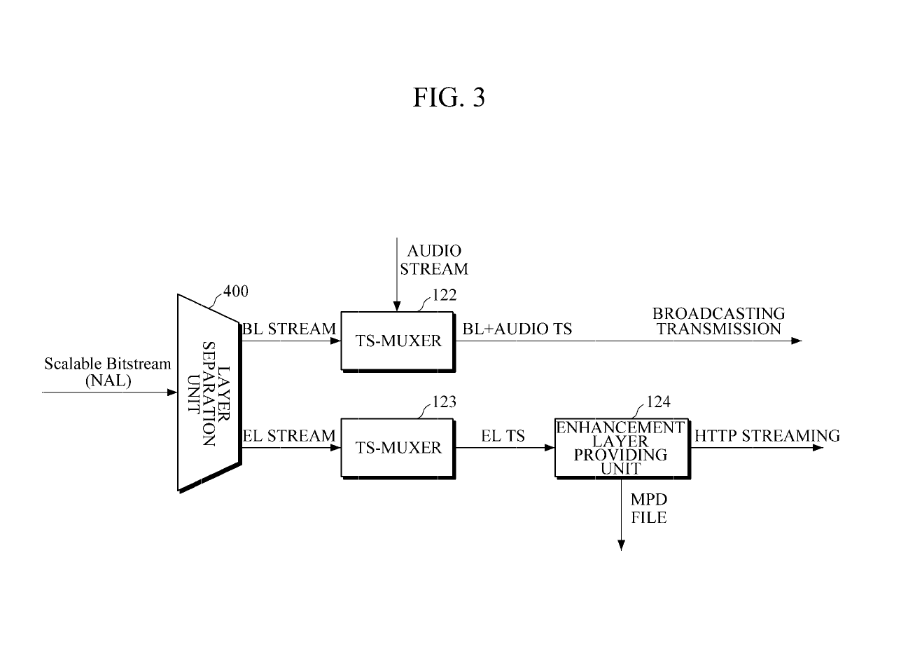

As illustrated in FIG. 3, the hybrid network transport streaming module 120 includes a layer separation unit 121, a TS multiplexer (muxer) 122 for the base layer, a TS multiplexer 123 for the enhancement layer, and an enhancement layer providing unit 124. The layer separation unit (NAL extractor) 121 separates the base layer and the enhancement layer. This layer separation unit 121 may be referred to as a network adaptation layer (NAL). The respective is separated layer streams are provided to the TS multiplexers 122 and 123. The TS multiplexer 122 for the base layer combines an encoded audio stream with a base layer stream to convert the base layer stream into an MPEG-2 transport stream (TS). The TS generated by combining the base layer with audio is transmitted through the broadcasting network so that a client may view a 2D image.

The TS multiplexer 123 for the enhancement layer converts only the enhancement layer into an MPEG-2 TS. This converted enhancement layer TS is generated into a stream that can be transmitted based on HTTP through the enhancement layer providing unit 124. Metadata needed for streaming are stored by establishing information on each element in a media presentation description (MPD) file. The stored MPD file is transmitted through the Internet network when requested by the client. The enhancement layer providing unit 124 segments the enhancement layer TS and stores the segmented TS file in a designated place so that the client may download the file. Since the enhancement layer stream is adaptive to an HTTP-based environment in order to be transmitted, the enhancement layer may be efficiently transmitted with respect to a channel or terminal environment when the number of generated enhancement layers is at least one. Further, a 3D content image (right image) may be provided from a point of time when 3D image is requested by the client while a 2D image (left image) is reproduced. The enhancement layer providing unit 124 may be referred to as a TS segmenter & MPD generator, because the enhancement layer providing unit 124 serves as a segmenter and an MPD generator.

The client system 200 may receive the base layer stream from the broadcasting network and the enhancement layer stream from the Internet network to provide a high-quality 3D image, and may adaptively provide a 2D compatible service according to a terminal. The client system 200 includes a hybrid network reception module 210, an adaptive SVC decoder 220, and a terminal for reproducing content.

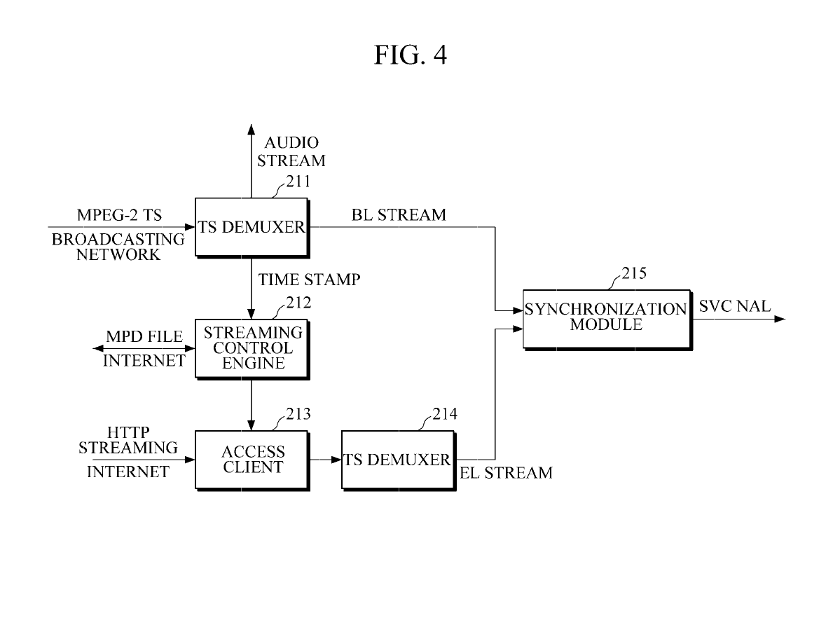

The hybrid network reception module 210 manages layers received through the broadcasting network and the Internet network, and synchronizes two layers. As illustrated in FIG. 4, the hybrid network reception module 210 includes a TS demultiplexer (demuxer) 211 for the base layer, a streaming control engine 212, an access client 213, a TS demultiplexer 214 for the enhancement layer, and a synchronization module 215. The base layer TS demultiplexer 211 separates the TS received through the broadcasting network into a base layer stream and an audio stream, and provides a time-stamp value of the base layer TS to the streaming control engine 212.

The streaming control engine 212 operates when a user of the terminal requests a 3D view. When the user requests a 3D view, the streaming control engine 212 requests the MPD file from the transport system 100 and receives the MPD file. The streaming control engine 212 determines a segmented TS file of a current time by using the MPD file containing the time stamp and segment information of a 2D image that has been transmitted through the broadcasting network and reproduced until the present time. The streaming control engine 212 identifies the determined segmented TS file to the access client 213 so that the determined segmented TS file is downloaded. In addition, when the user requests the 3D view while viewing 2D images, the client system 200 may receive another image (right image) of a currently output 2D image (left image) through the Internet network to output a 3D image. Here, since the image should be provided from the same time point as the currently reproduced 2D image, the streaming control engine 212 analyzes the time stamp provided from the TS demultiplexer 211 of the base layer and the MPD file received from the transport system 100 so as to determine the segmented TS file of the current time.

The HTTP access client 213 downloads, through a designated URL link, a segmented file from a position instructed by the streaming control engine 212, and transfers the downloaded segmented TS to the TS demultiplexer 214 of the enhancement layer. The TS demultiplexer 214 of the enhancement layer converts the TS file into an encoded stream of the enhancement layer and outputs the converted stream. The encoded streams generated by the TS demultiplexer 211 for the base layer and the TS demultiplexer 214 for the enhancement layer are provided to the synchronization module 215. The synchronization module 215 synchronizes the encoded stream of the base layer with the encoded stream of the enhancement layer to generate a single scalable bitstream (SVC NAL). The synchronization module 215 performs the synchronization by using the TS time stamp values of the base layer and the enhancement layer.

The scalable bitstream generated by the synchronization module 215 is provided to the adaptive SVC decoder 220. Similarly to a typical decoder, the adaptive SVC decoder 220 is configured with a single decoder. However, the adaptive SVC decoder 220 according to one aspect of the present invention may determine the output number of restored images through the SEI message encoded by the SVC encoder 110 in order to perform decoding.

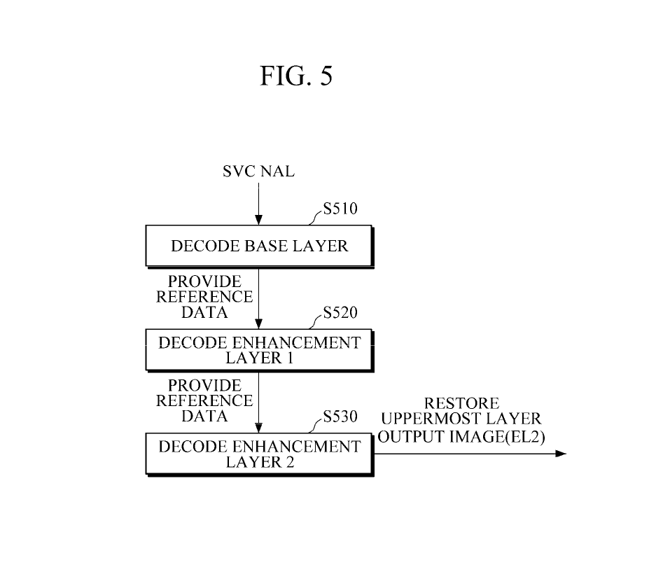

FIG. 5 is a diagram illustrating a standard SVC decoding operation.

As illustrated in FIG. 5, when a 3-layer-structured encoded bitstream is input to the standard SVC decoder, the restored images of the base layer and the enhancement layer are only used as reference data. That is, the conventional standard SVC decoder receives the encoded bitstream (SVC NAL) to analyze header information and decode the base layer (operation 510). The standard SVC decoder decodes a lower enhancement layer using the reference data obtained from operation 510 (operation 520), and then decodes an uppermost enhancement layer using the is reference data obtained therefrom, so as to output an image having the quality of the uppermost layer.

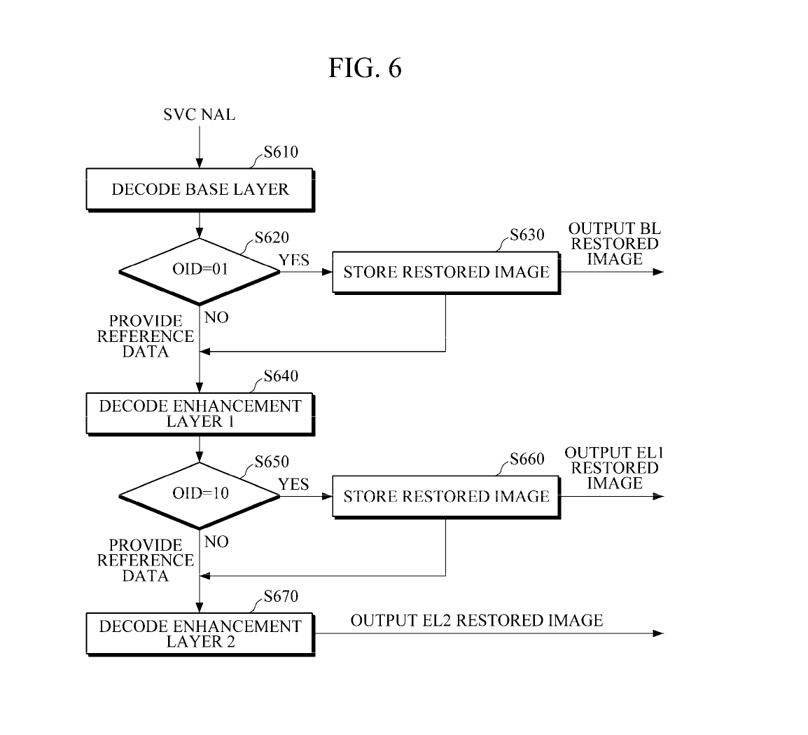

FIG. 6 is a diagram illustrating an SVC decoding method according to an embodiment of the present invention.

In comparison with the standard SVC decoding method, enhanced technology for a 3D service is additionally applied to the adaptive SVC decoder 220. This will be described in detail below. The adaptive SVC decoder 220 analyzes the header information of the SVC NAL data and decodes the base layer (operation 610). The adaptive SVC decoder 220 determines whether the OID value specified in the SEI of the header information is ‘01’ (operation 620). When the value is ‘01’, the adaptive SVC decoder 220 stores, in a temporary buffer, a base layer image restored through decoding (operation 630). The adaptive SVC decoder 220 decodes a lower enhancement layer (enhancement layer 1) using the reference data obtained through the base layer decoding (operation 640). When it is determined that the OID value is not ‘01’ in operation 630, the adaptive SVC decoder 220 determines whether the OID value is ‘10’ (operation 650). When the value is ‘10’, the adaptive SVC decoder 220 stores, in the temporary buffer, a lower enhancement layer image restored through decoding (operation 660). Thereafter, the adaptive SVC decoder 220 decodes the uppermost enhancement layer using the reference data obtained through the lower enhancement layer decoding (operation 670). The decoded uppermost enhancement layer is output to the terminal. Here, according to the OID value, the base layer or lower enhancement layer stored in the temporary buffer is output together. When the OID value is ‘01’, the base layer is restored and stored in the temporary buffer, and is output together when the uppermost enhancement layer (enhancement layer 2) is restored and output. When the OID value is ‘10’, the lower enhancement layer is restored and stored in the temporary buffer, and is output together when the uppermost enhancement layer is restored and output.

The conventional standard SVC decoder receives the SVC NAL information to analyze header information and decode the base layer. The decoded base layer is used as the reference data for decoding enhancement layers, and then is discarded. Through this process, the conventional SVC outputs an image for the uppermost layer. However, the adaptive SVC decoder 220 according to the present invention has the same functions as the conventional SVC decoder and is compatible therewith. Further, the adaptive SVC decoder 220 simultaneously outputs the base layer and the enhancement layer through the OID information specified in the SEI of the header information. When the OID information is not included in the SEI header, the adaptive SVC decoder 220 recognizes an initial value ‘00’ of the OID to perform decoding in the same manner as the conventional method.

According to the present invention, encoding and decoding can be performed with one codec, a quality difference between two images can be reduced, and a full HD image service can be provided at a lower bit rate than in a conventional method. Further, not only the 2D compatible 3D service but also a multi-resolution 2D service and a multi-resolution 3D service can be provided.

In addition, according to the present invention, since only the enhancement layer decoded based on the information of the base layer is transmitted through the Internet, content can be protected without additional content protection means.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transport system for a hybrid 3D content service, comprising:
an SVC encoder configured to encode 3D content of a left image and a right image; and
a hybrid network transport streaming module configured to transmit a base layer (BL) stream from among scalable bitstreams encoded by the SVC encoder to a client system through a broadcasting network, and to transmit an enhancement layer (EL) stream to the client system through an Internet network.

2. The transport system of claim 1, wherein the hybrid network transport streaming module transmits the enhancement layer stream when the enhancement layer stream is requested by the client system.

3. The transport system of claim 2, wherein the SVC encoder includes, into is supplemental enhancement information (SEI), information on the number of video images to be output by a decoder of the client system according to a type of the 3D content.

4. The transport system of claim 3, wherein the hybrid network transport streaming module comprises:
a layer separation unit configured to separate the scalable bitstream encoded by the SVC encoder into a base layer and an enhancement layer;
a base layer TS multiplexer configured to convert the separated base layer stream into a transport stream (TS);
an enhancement layer TS multiplexer configured to convert the separated enhancement layer stream into a transport stream; and
an enhancement layer providing unit configured to segment and store the enhancement layer transport stream, and stream-transmit a segment file of a corresponding point of time when the client system requests.

5. The transport system of claim 4, wherein the base layer TS multiplexer combines the separated base layer stream with an audio stream.

6. The transport system of claim 4, wherein the enhancement layer providing unit generates a media presentation description (MPD) file including information of the segmented enhancement layer transport stream, and provides the file when the file is requested by the client system.

7. The transport system of claim 6, wherein the enhancement layer providing unit performs streaming-transmission based on a hyper text transfer protocol (HTTP).

8. A client system for a hybrid 3D content service, comprising:
a hybrid network reception module configured to receive a transport stream (TS) including a base layer stream through a broadcasting network, and to receive an enhancement layer stream through an Internet network, from a transport system, wherein the hybrid network reception module requests the enhancement layer stream from the transport system to receive the enhancement layer stream; and
an adaptive SVC decoder configured to decode the streams received by the hybrid network reception module and output a 2D or 3D image.

9. The client system of claim 8, wherein the hybrid network reception module comprises:
a TS demultiplexer for a base layer, configured to separate a transport stream received through the broadcasting network into a base layer stream and an audio stream;
a streaming control engine configured to request a media presentation description (MPD) file to the transport system and receive the media presentation description (MPD) file from the transport system, analyze a time stamp of a 2D image provided from the TS demultiplexer for the base layer and segment information of the received MPD file, and determine an enhancement layer segment TS file of a download start time;
an access client configured to download, from the transport system, the segment TS file of a time determined by the streaming control engine;
is a TS demultiplexer for an enhancement layer configured to convert the downloaded enhancement layer TS file into an enhancement layer stream; and
a synchronization module configured to synchronize the base layer stream with the enhancement layer stream to generate SVC NAL data that is a single scalable bitstream.

10. The client system of claim 9, wherein the streaming control engine sends a request to the transport system for the MPD file from when a user requests a 3D view.

11. The client system of claim 9, wherein the adaptive SVC decoder identifies supplemental enhancement information (SEI) included in a header of an SVC network adaptation layer (NAL) that is a single scalable bitstream generated by the synchronization module, detects the number of output images, and outputs a 2D or 3D image according to the detected number.
